(19) United States
(12) Patent Application Publication
(10) Pub. No.: US 2004/0225690 A1
(43) Pub. Date: Nov. 11, 2004

(54) Preventing Inadvertent file deletion, renaming, and moving

(75) Inventors: Woodrow Wyatt Arkeketa, Austin, TX (US); Vijaylaxmi Chakravarty, Austin, TX (US); Shengdong Chen, Cedar Park, TX (US)

Correspondence Address: PAUL D. HEYDON, PATENT ATTORNEY, 3004 NACOGDOCHES ROAD, SAN ANTONIO, TX, 78217, US

(73) Assignee: International Business Machines Corporation, Armonk, NY

(21) Appl. No.: 10/434,501

(22) Filed: May 8, 2003

(51) Int. Cl. G06F 17/30

(52) U.S. Cl. 707/200

(57) ABSTRACT

A solution provided here comprises providing a dependency-aware mode, receiving a command to perform an operation on a target file, searching stored dependency information, for a subset of information that corresponds to the target file, and retrieving the subset of information if it is found. In some cases, such a solution might also comprise providing special delete, special rename, and special move operations, designating one or more protected programs, preserving access to files that are associated with a protected program, or choosing one or more additional files to be deleted.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to information handling, and more particularly to file management, for software and information—handling systems.

### BACKGROUND OF THE INVENTION

Typically a computer user may desire to move or delete a file, or to delete an unwanted software product consisting of many files, without accidentally losing access to a file that a valuable program depends on for its proper function. Various approaches have been proposed for recovering files that have been deleted accidentally, but these examples do not address prevention of accidental file deletion. Some tools for the installation or uninstallation of software may make limited use of dependency information, but such tools do not necessarily make effective use of dependency information for various file-management tasks. Thus there is a need for systems and methods that effectively utilize dependency information for preserving access to files that are needed, while performing file management.

### SUMMARY OF THE INVENTION

A solution to problems mentioned above comprises providing a dependency-aware mode, receiving a command to perform an operation on a target file, searching stored dependency information, for a subset of information that corresponds to the target file, and retrieving the subset of information if it is found.

In some cases, such a solution might also comprise providing special delete, special rename, and special move operations, designating one or more protected programs, preserving access to files that are associated with a protected program, or choosing one or more additional files to be deleted.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a block diagram showing an example of a system and method for managing files, according to the present invention.

FIG. 3 is a flow chart illustrating an example of a method for managing files, according to the present invention.

FIG. 4 is a flow chart illustrating an example of designating a protected program, handling stored dependency information, and preserving access to files that are associated with the protected program.

### DETAILED DESCRIPTION

The examples that follow involve the use of one or more computers and may involve the use of one or more communications networks. The present invention is not limited as to the type of computer on which it runs, and not limited as to the type of network used.

The following are definitions of terms used in the description of the present invention and in the claims:

“Application” means any specific use for computer technology, or any software that allows a specific use for computer technology.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Delete” means to erase, remove, or uninstall.

“Dependency” refers to any condition where certain data, files, hardware, or software are required for proper operation.

“Dependency-aware” means capable of using information about dependency.

“File” means any stored collection of bits or bytes, including but not limited to an executable program, source code, text, data, audio, graphics, or video.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Target file” means any file on which a user intends to perform an operation.

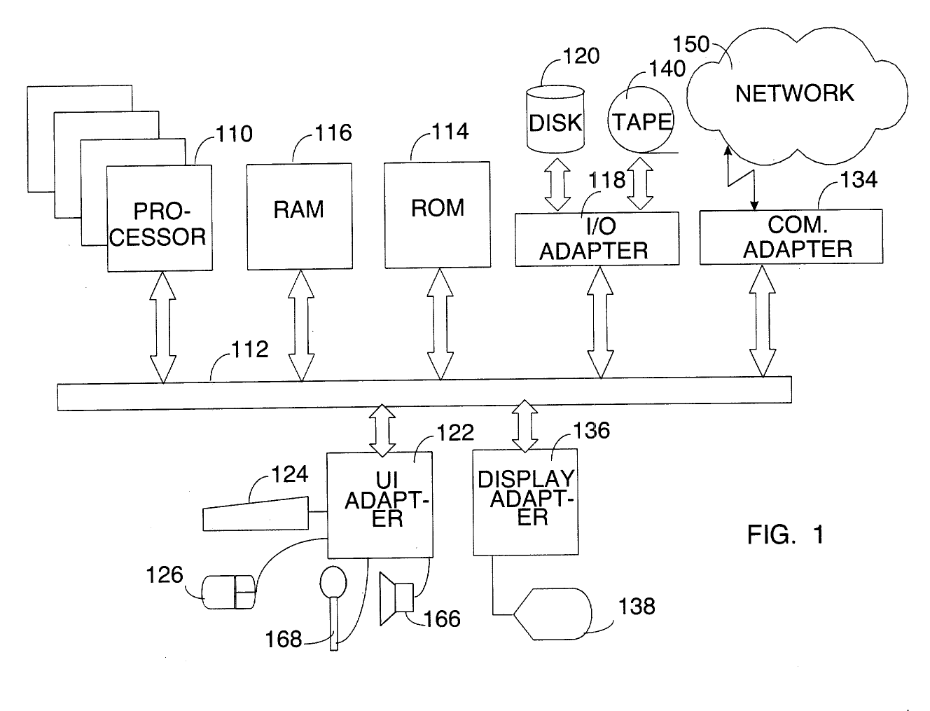

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

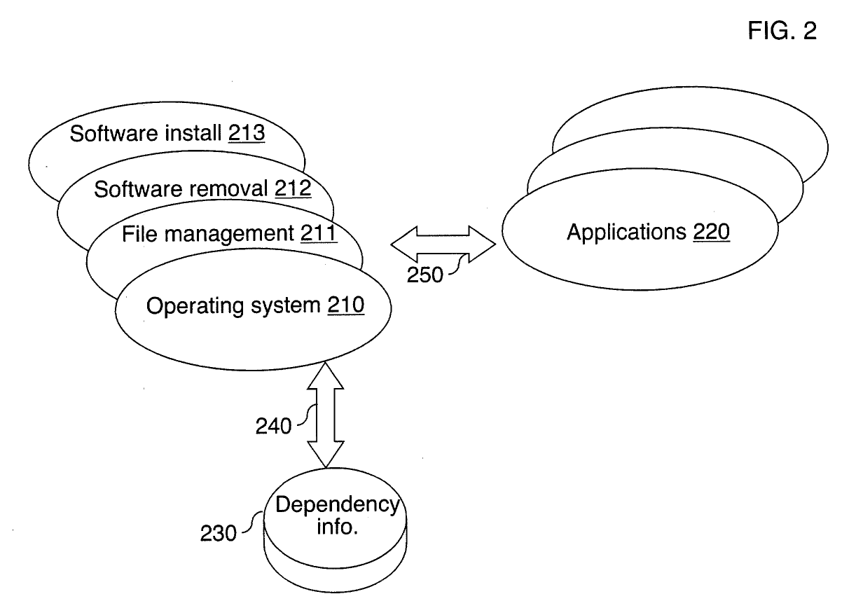

FIG. 2 is a block diagram showing an example of a system and method for managing files, according to the present invention. The example in FIG. 2 might involve a computer shared by a number of users, or one individual's computer. To begin with an overview, operating system 210, file-management component 211, software-removal component 212, and software-installation component 213 symbolize some software components that may be used to implement the present invention. They may perform various operations on files, including adding, moving, renaming or deleting files associated with applications at 220. The double-headed arrow 250 to the left of applications at 220 symbolizes performance of operations on files. Another example of a component that could be included in this group of components 210-213 is a component that updates applications at 220 by obtaining files via a network and installing the files.

The example in FIG. 2 involves providing a dependency-aware mode, searching stored dependency information (at 230), and preserving access to files that are associated with a protected program. Preserving access to files may involve taking precautions when moving or renaming files, or preventing deletion. The example in FIG. 2 also involves choosing one or more additional files to be deleted, so that when a program (among applications at 220) is no longer needed, a set of associated files may be deleted.

Turning to some details of FIG. 2, operating system 210, file-management component 211, software-removal component 212, or software-installation component 213 may serve as means for providing a dependency-aware mode, by providing special delete, special rename, and special move operations, or designating one or more protected programs (among applications at 220), for example. The protected programs and dependency information may be stored and displayed in a list like the example in Table 1.

TABLE 1

| | Column 2: Files (Complete |
|---|---|
| Column 1; Program | paths not shown here) |
| NT OS | Isass.exe, advapi32.dll, |
| | perfmon.exe, etc. |
| MS WORD | winword.exe, winspool.dll, etc. |
| ACROBAT READER | AcroRd32.exe, Acrofx32.dll, |
| | etc. |
| INTERNET EXPLORER | lexplore.exe, hmmapi.dll, etc. |
| LOTUS SAMETIME | Connect.exe, omui.dll, |
| | activmon.dll, etc. |
| TIVOLI ACCESS MANAGER | ivauthn.dll, adutil.dll, rspiad.dll, |
| | etc. |
| [Dynamically add programs to | |
| this list] | |

In Table 1, some protected programs are shown in the column on the left. A set of files that corresponds to each protected program is shown in the column on the right. Each protected program depends, for proper operation, on the set of files that is shown in the column on the right.

A user interface or checklist similar to Table 1 may serve as a means for receiving inputs from a user, designating one or more protected programs, for example. Programs and their files may be added to the list dynamically, as indicated by the notation at the lower end of Table 1. A user interface similar to Table 1 may serve as a means for providing a message, describing files that are associated with each protected program, or a means for preventing deletion of files that are associated with a protected program. A user interface similar to Table 1 may serve as a means for choosing one or more additional files to be deleted, so that when a program is no longer needed, a complete set of associated files may be deleted. A user interface, message or list may be provided in various ways, including but not limited to printing on paper, or displaying on a screen, or using an audio device. The protected programs shown in this example are software products sold under the trademarks LOTUS SAMETIME, and TIVOLI ACCESS MANAGER by IBM, software products sold under the trademarks WINDOWS NT, WORD, and INTERNET EXPLORER by Microsoft Corporation, and the software product sold under the trademark ACROBAT READER by Adobe Systems Incorporated.

Operating system 210, file-management component 211, software-removal component 212, or software-installation component 213 may serve as means for receiving a command to perform an operation on a target file. The target file or files may be found among applications at 220. Operating system 210, file-management component 211, software-removal component 212, or software-installation component 213 may serve as means for searching stored dependency information 230, for a subset of the stored dependency information that corresponds to the target file, and as means for retrieving the subset if it is found.

The double-headed arrow 240 above stored dependency information 230 symbolizes storing, searching and retrieving. Stored dependency information 230 may be stored in any kind of computer memory or storage device, such as in Random Access Memory (RAM), on a hard disk of a user's computer, or on a remote computer. Stored dependency information 230 may be implemented as a database that is available to multiple software components, for example. One way to obtain dependency information to store in 230 is through software-installation tools, that can provide lists of files when applications 220 are installed on a user's computer. In other words, one approach is obtaining at least part of the dependency information from a software-installation component, when software is installed. Another approach is to utilize the operating system 210. The operating system 210 could execute a program and get its dependency information by seeing what files are being loaded by the loader when the program is run. (Typically the loader is a part of operating system 210.) However, programs may dynamically load some modules, and not load others, depending on the nature of work being done by the program. So, the operating system 210 may not be able to get all the files that a program uses merely by running the program.

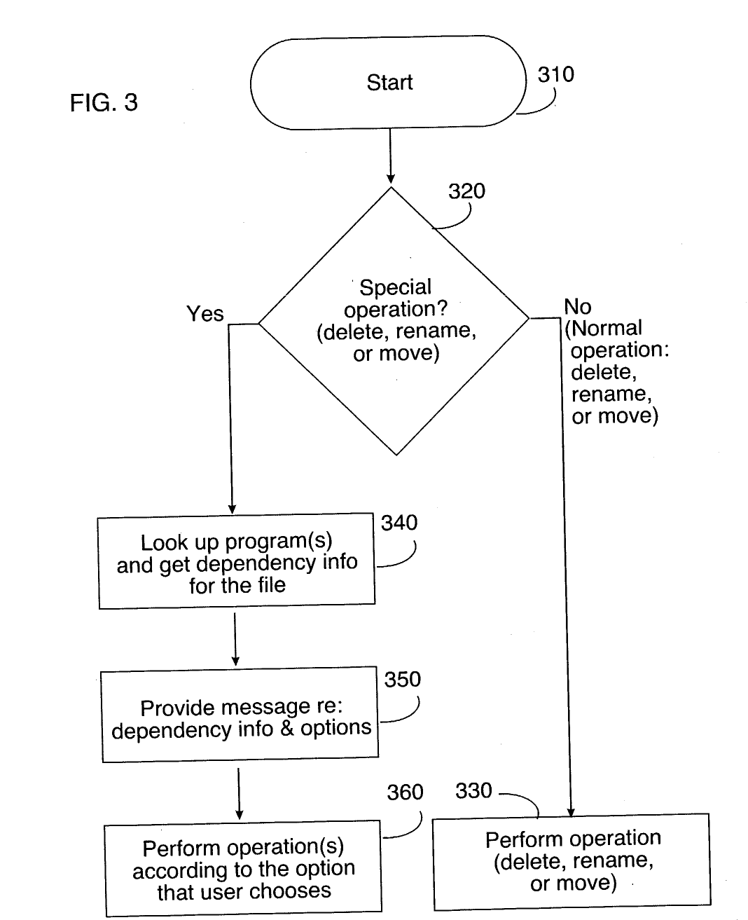

FIG. 3 is a flow chart illustrating an example of a method for managing files, according to the present invention. In this example, the process starts at block 310, symbolizing a starting point for operations on files (e.g. operations to delete, move or rename a file). This is followed by decision 320, symbolizing a user's decision whether to utilize special delete, special rename, or special move operations. The special operations (the “Yes” branch, on the left side of FIG. 3) may be implemented as a program that looks up dependency information for the target file and prompts the user. When a user tries to delete a file for example, this cached information is looked up (block 340), to see whether this target file is used by any protected program. An inordinate amount of memory and processor time might be required for searching dependency information every time a file is deleted. Thus an option is provided for two modes of operations. This option provides flexibility, allowing use of the cached dependency information only when desired. The special delete operation does the cache lookup, and the user is warned (block 350), if the target file is used by a protected program. This prevents the user from accidentally deleting files that are required for proper operation of a program. On the other hand, if the target file is not used by a program, deletion is allowed without warning (by an operating system or file-management component, for example).

If a user decides to utilize a normal delete, rename, or move operation, then the “No” branch is taken at decision 320. This branch does not use the cached dependency information. Next, at block 330, a normal delete, rename, or move operation is performed.

Turning to details of the “Yes” branch at decision 320, an operating system or another component receives a command to perform an operation on a target file (e.g. a special delete, special rename, or special move operation). Next, at block 340, an operating system or another component utilizes stored dependency information, looking up a list of programs and getting dependency information for the target file. This example assumes that the designation of at least one protected program has occurred, and a list similar to the example in Table 1 exists. In other words, block 340 involves searching stored dependency information, for a subset of information that corresponds to the target file, and retrieving the subset of information if it is found.

Turning to details of searching, at FIG. 3, block 340, consider the example in Table 2 below.

TABLE 2

| | Column 2: Files (Complete |
|---|---|
| Column 1; Program | paths not shown here) |
| A | abc.dll, dce.dll, etc. |
| B | abc.dll, dfg.dll, etc. |
| C | abc.dll, etc. |

When the user wishes to perform an operation on the target file (such as special delete, special move, or special rename), Column 2 of Table 2 is searched to see if that file is present. Column 2 is a list; for example, we can use a linked list, an array or a binary tree to organize the column. Various data structures may be used for column 2. Assuming an appropriate data structure is used, any standard search algorithm may be used.

Referring back to Table 1 or Table 2, it is possible to have a file in column 2 that corresponds to more than one program in column 1. Usually a library file is shared by more than one program. For example, programs A, B, and C may all use abc.dll, as shown in Table 2. We might stop the search for a particular target file the first time we find it in column 2 of any protected program. The message (see block 350) might inform the user that one or more protected programs are using the target file. Here, we are sure that the target file is being used by at least one protected program.

Alternately we might search for all occurrences of the target file in column 2 of the table. In this case, a message (see block 350) might inform the user of all the programs that the target file belongs to.

Note that searches for target files involve the complete paths of the files. Complete paths are stored in column 2, although this is not shown in Table 1 or Table 2, to make the examples easier to read.

As an alternative example, consider Table 3 below.

TABLE 3

| Column 1: Files (Complete | |
|---|---|
| paths not shown here) | Column 2; Programs |
| abc.dll | A, B, C, etc. |
| dce.dll | B |
| dfg.dll | B |

In Table 3, Column 1 has the file names, and Column 2 has the programs that a file belongs to. If we were to use Table 3, we would search Column 1 for the target file. Column 1 has only one entry and it could be sorted.

Irrespective of whether we use Table 2 or Table 3, entries are removed when software is uninstalled or a file is removed.

Next in FIG. 3 is block 350, providing a message regarding dependency information and options. This might involve providing a message, describing files that are associated with a protected program. This information may be used in preventing deletion of files that are associated with a protected program, or otherwise preserving access to these files. On the other hand, this information may be used in choosing one or more additional files to be deleted. A message may describe a set of associated files that may be deleted, when a program is no longer needed. Operations at block 350 might involve providing a list of options for the user, based on the subset of information that is retrieved. There may be an option to ensure that after it is moved, a file is in the search path for a program that requires it.

Next is block 360, performing one or more operations that a user chooses. In some cases, this might involve choosing one or more additional files to be deleted, based on the retrieved information. Thus a set of associated files may be deleted, when a protected program is no longer needed. In some cases, block 360 might involve choosing to delete one or more additional files that are associated with a target file, and searching is also performed for files not associated with a protected program. However, an inordinate amount of memory and processor time might be required for storing and searching dependency information for all programs on a computer. Thus an option is provided for designating one or more protected programs, to limit the resources required for storing and searching.

Operations at block 360 might involve deleting one or more user-generated files that are associated with a target file. With conventional software-removal components (uninstallers), when a program is uninstalled, the files associated with it that are user generated are not deleted. The present invention may also maintain (as part of the stored dependency information) a list of files that a user creates when working with a particular program. Using this list, the present invention can prompt the user to delete those user-generated files (e.g. configuration files) as well when the program is uninstalled.

Operations at block 360 might involve deleting from a system folder one or more files that are associated with a target file. Some files associated with a program may be installed in the system folder. When the user no longer wants to use this program and uninstalls it, some files may remain in the system folder. Since the files are in the system folder, the user may hesitate to delete them, as the user might think the files are being used by the operating system. The user may be prompted to delete from a system folder one or more files when the program is uninstalled.

Consider another example in connection with block 360. When the user no longer wants to use a program and uninstalls it, the user could also be prompted with a list of all the registry items updated by this program, and choose to remove those as well. The present invention may also maintain (as part of the stored dependency information) a list all the registry entries associated with the program. (This example involves a registry in operating system software products, sold under the trademarks WINDOWS NT, or WINDOWS 2000, by Microsoft Corporation. However, the present invention is not limited as to the type of operating system or application software that may be used.)

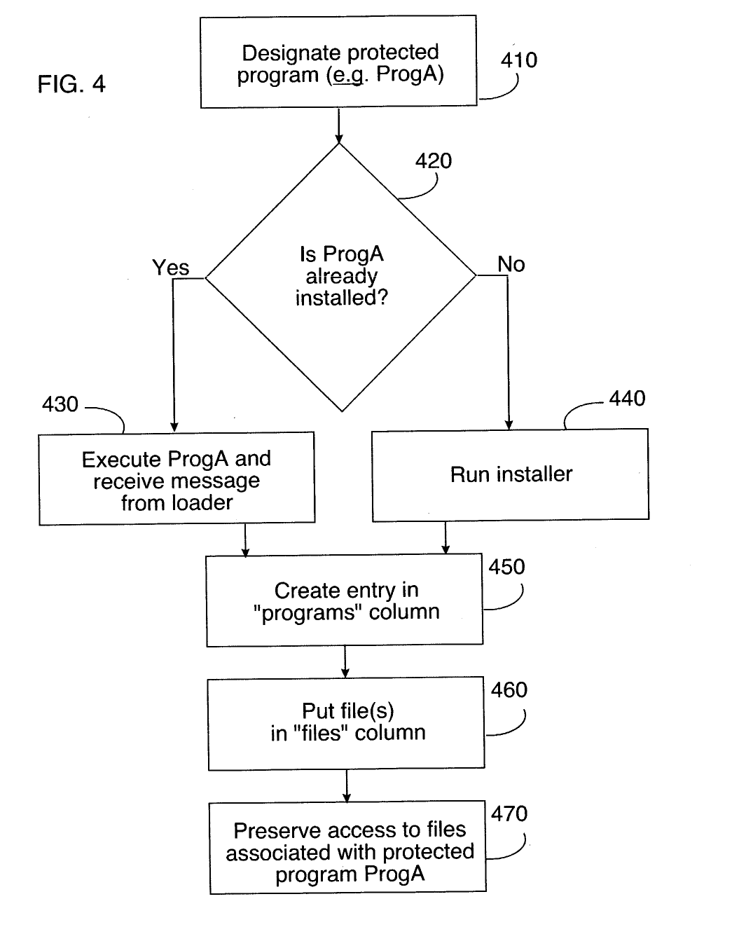

FIG. 4 is a flow chart illustrating an example of designating a protected program, handling stored dependency information, and preserving access to files that are associated with the protected program. The example in FIG. 4 begins at block 410, designating a protected program. This may involve receiving inputs from a user through a user interface of some kind. Consider a program named “progA” for example. At block 410, progA may be designated as a protected program. This example continues with ways of creating entries in a table like Table 1 or Table 2.

As shown by decision 420 and the two separate branches, progA may be designated as a protected program at the time it is installed, or some time after it is installed. At decision 420, if progA is already installed, the “Yes” branch is taken.

At block 430, when progA is executed, progA-related libraries and files are loaded by a system program, called a “loader.” Typically the loader is a part of an operating system. A new program called “loadMonitor” runs at the operating system level and monitors the loader. The loader loads a new file related to progA, named “progA_file,” for example. The loader sends a message (progA, progA_file) to loadMonitor, and loadMonitor receives the message (progA, progA_file) from the loader. Note: current loaders need to be modified in order to be able to send a message to loadMonitor.

At block 450, if progA is not in the “programs” column (e.g. column 1 of Table 2), loadMonitor creates an entry for progA in column 1, and at block 460, loadMonitor puts the file progA_file in the “files” column 2. If progA is already in column 1, loadMonitor checks to see if progA_file is in column 2 against progA. If not, loadMonitor puts the file progA_file in column 2, against the entry for progA. If the progA_file is in column 2 against progA, loadMonitor does not update the table.

At decision 420, if progA is not yet installed, the “No” branch is taken. Block 440 symbolizes running a software installer, to install software that the user wishes to protect. At block 450, the software installer creates an entry in the programs column 1 for the software. At block 460, the software installer puts the names of the files it is installing in column 2, against the software name. Note: current software installers need to be modified to provide this facility.

Finally, as shown by block 470, this example involves preserving access to files that are associated with the protected program progA. Stored dependency information may be updated by the operations at blocks 450 and 460, and utilized to preserve access to files that are associated with protected programs. This might involve providing a message to a user and thus preventing deletion of files. Operations at block 470 might involve providing a list of options for the user, including an option to ensure that after moving or renaming, a file is in the search path for a program that requires it. (See also FIG. 3 at block 350.)

Regarding FIGS. 3 and 4, the order of the operations described above may be varied. Those skilled in the art will recognize that blocks in FIGS. 3 and 4, described above, could be arranged in a somewhat different order, but still describe the invention. Blocks could be added to the above-mentioned diagrams to describe details, or optional features; some blocks could be subtracted to show a simplified example. Separate paths could be described for operations such as moving, renaming, or updating, for example.

In conclusion, we have shown examples of solutions utilizing dependency information for managing files.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method for managing files, said method comprising:
providing a dependency-aware mode;
receiving a command to perform an operation on a target file;
searching stored dependency information, for a subset of said stored dependency information that corresponds to said target file; and
retrieving said subset if it is found.

2. The method of claim 1, wherein said providing a dependency-aware mode further comprises:
providing special delete, special rename, and special move operations.

3. The method of claim 1, wherein said providing a dependency-aware mode further comprises:
designating at least one protected program.

4. The method of claim 3, further comprising:
preserving access to files that are associated with said at least one protected program.

5. The method of claim 1, further comprising:
providing a message, based on said subset;
whereby files required for proper operation of a program may be protected from inadvertent deletion.

6. The method of claim 1, further comprising:
choosing at least one additional file to be deleted, based on said subset;
whereby files may be deleted, when no longer needed.

7. The method of claim 1, further comprising:
deleting at least one user-generated file that is associated with said target file.

8. The method of claim 1, further comprising:
providing a list of options, based on said subset.

9. The method of claim 1, further comprising:
making said stored dependency information available to a plurality of software components.

10. The method of claim 1, wherein said stored dependency information is generated by one or more components selected from the group consisting of an operating system,
a file-management component,
a software-removal component, and
a software-installation component.

11. A system for managing files, said system comprising:
means for providing a dependency-aware mode;
means for receiving a command to perform an operation on a target file;
means for searching stored dependency information, for a subset of said stored dependency information that corresponds to said target file; and
means for retrieving said subset if it is found.

12. The system of claim 11, wherein said means for providing a dependency-aware mode further comprises:
means for providing special delete, special rename, and special move operations.

13. The system of claim 11, wherein said means for providing a dependency-aware mode further comprises:
means for designating at least one protected program.

14. The system of claim 11, further comprising:
means for preventing deletion of files, based on said subset; and
means for choosing at least one additional file to be deleted, based on said subset.

15. The system of claim 11, further comprising:
means for making said stored dependency information available to a plurality of software components.

16. A computer-usable medium having computer-executable instructions for managing files, said computer-executable instructions comprising:
means for providing a dependency-aware mode;
means for receiving a command to perform an operation on a target file;
means for searching stored dependency information, for a subset of said stored dependency information that corresponds to said target file; and
means for retrieving said subset if it is found.

17. The computer-usable medium of claim 16, wherein said means for providing a dependency-aware mode further comprises:
means for providing special delete, special rename, and special move operations.

18. The computer-usable medium of claim 16, wherein said means for providing a dependency-aware mode further comprises:
means for designating at least one protected program.

19. The computer-usable medium of claim 16, further comprising:
means for preventing deletion of files, based on said subset; and
means for choosing at least one additional file to be deleted, based on said subset.

20. The computer-usable medium of claim 16, further comprising:
means for making said stored dependency information available to a plurality of software components.
